(19) United States
(12) Patent Application Publication
(10) Pub. No.: US 2022/0172266 A1
(43) Pub. Date: Jun. 2, 2022

(54) DIGITAL BUSINESS-TO-BUSINESS VENDOR EVALUATION AND PURCHASE PROCESS COLLABORATION PLATFORM

(71) Applicant: Forcastable, Inc., Lake Mary, FL (US)

(72) Inventors: Alexander Buckles, Lake Mary, FL (US); Vishal Jiawon, Orlando, FL (US); Paul Johnson, Orlando, FL (US); Landon Bass, Tampa, FL (US)

(73) Assignee: Forcastable, Inc., Lake Mary, FL (US)

(21) Appl. No.: 17/108,287

(22) Filed: Dec. 1, 2020

(51) Int. Cl. G06Q 30/06; G06Q 10/10

(52) U.S. Cl. CPC G06Q 30/0613; G06Q 10/105; G06Q 10/103; G06Q 30/016; G06Q 30/0605; G06Q 30/0643; G06Q 30/0609

(57) ABSTRACT

An evaluation system for a good/service is disclosed which includes a seller computer and a buyer computer in operable connection with a network. An application server is in operable communication with the network to host an application system for generating an evaluation plan. The application system includes a user interface in operable communication with a buyer database, a good/service database, and an evaluation plan database. The user interface includes an evaluation center interface configured for permitting users to evaluate goods or services while comparing the goods and services to third-party vendors. A desired business outcomes database is configured for displaying one or more business outcomes. An evaluation considerations interface is configured for displaying one or more evaluation considerations. An evaluation plan interface is configured for displaying an evaluation plan. A video/document interface is configured for displaying at least one video or document.

### TECHNICAL FIELD

The present embodiments relate to computerized systems for client relationship management and evaluation and more specifically to computerized systems for allowing prospective clients to evaluate and compare products and services within a sales platform.

### BACKGROUND

Client relationship management (CRM) systems allow a company to manage and analyze interactions with their past, current and potential customers to promote long-lasting relationships with clients and drive sales growth. Social network services are a rich source of information about a company and its employees and may be used by CRM systems and the professionals using them. For example, sales professionals may utilize the social network service to search for profiles of decision makers within a company of interest with which the sale professional would like to initiate a sales transaction or partnership.

Often, information provided by the social media service can be organized into what is known as a “social graph” or similar visual representation of individuals within a company of interest which can be used to determine who to contact regarding a particular product, service, or partnership being presented by the sales professional. However, in many systems this information may be fragmented from sales notes or other useful information known to the sales professional or associate thereof.

Testing products sold by sales representatives is often disjointed from the sales process. Product demonstrations provide a way for the sales representative to interact with the buyer, demonstrate the capabilities of the product, and assess the buyer's interest. However, the sales representative is burdened with assessing the buyer's concerns and determining if their product will benefit the buyer based on their goals.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments provided herein relate to an evaluation system for a good or service provided to permit a buyer to evaluate the good or service and compare the good or service to third-party vendors. Further, the system will permit vendors to collaborate around the purchase process.

At least one seller computer and at least one buyer computer are in operable connection with a network. An application server is in operable communication with the network to host an application system for generating an evaluation plan. The application system includes a user interface for providing a user with access to the application system to the seller computer and the computer. The user interface is in operable communication with: a buyer database, a good/service database, and an evaluation plan database. The user interface includes an evaluation center interface configured for permitting users to evaluate goods or services while comparing the goods and services to third-party vendors. A desired business outcomes database is configured for displaying one or more buyer-defined desired business outcomes. An evaluation considerations interface is configured for displaying one or more evaluation considerations. An evaluation plan interface is configured for displaying at least one evaluation plan. A video/document interface is configured for displaying at least one video or document.

In one aspect, the buyer database stores a plurality of buyer information comprising at least one of the following: a name, a position, a functional role, and a location.

In one aspect, the evaluation center interface is accessible by the seller computing device, the buyer computing device, and a third-party.

In one aspect, the evaluation plan is comprised of one or more milestones representing a process in a sales cycle.

In one aspect, each of the one or more milestones includes milestone information comprising: a name, a target date, and actual data, and an owner.

In one aspect, a seller management interface is configured to display a representation of the milestones.

In one aspect, at least one video or document is a product demo provided by the seller computing device.

In one aspect, each of the one or more evaluation considerations is validated by the seller or the buyer.

In one aspect, a buyer map interface is configured to receive a plurality of buyer information stored in the buyer database and generate, via a buyer map generator, a buyer map including one or more buyers from the plurality of buyer information.

In one aspect, a comment interface is configured to receive at least one communication and display the communication via the buyer map interface.

In one aspect, an accounts interface is configured to display a plurality of accounts, wherein each of the plurality of accounts are associated with one or more buyers.

In one aspect, the buyer map interface includes one or more buyer cell interfaces each displaying the plurality of buyer information. The buyer cell interfaces may include a support status indicator to indicate whether or not the buyer supports the good or service offered by the seller.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a screenshot of the network infrastructure, according to some embodiments;

FIG. 2 illustrates a flowchart of the sales cycle utilized by the CRM and evaluation systems, according to some embodiments;

FIG. 3 illustrates a screenshot of the evaluation plan interface, according to some embodiments;

FIG. 4 illustrates a screenshot of the accounts interface, according to some embodiments;

FIG. 5 illustrates a block diagram of the CRM system, according to some embodiments;

FIG. 6 illustrates a screenshot of the web browser plugin interface, according to some embodiments;

FIG. 7 illustrates a screenshot of the buyer enrichment interface, according to some embodiments;

FIG. 8 illustrates a screenshot of the buyer map interface, according to some embodiments;

FIG. 9 illustrates a method for generating a buyer map, according to some embodiments;

FIG. 10 illustrates a screenshot of the buyer cell interface, according to some embodiments;

FIG. 11 illustrates a block diagram of the buyer map generator, according to some embodiments;

FIG. 12 illustrates a screenshot of the seller management interface, according to some embodiments;

FIG. 13 illustrates a screenshot of the evaluation center interface, according to some embodiments;

FIG. 14 illustrates a screenshot of the desired business outcomes interface, according to some embodiments;

FIG. 15 illustrates a screenshot of the evaluation considerations interface, according to some embodiments;

FIG. 16 illustrates a screenshot of the evaluation plan timeline interface, according to some embodiments;

FIG. 17 illustrates a screenshot of the videos and documents interface, according to some embodiments;

FIG. 18 illustrates a block diagram of the evaluation center generator, according to some embodiments;

FIG. 19 illustrates a flowchart of the good or service evaluation process, according to some embodiments; and

FIG. 20 illustrates a block diagram of the application system, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, the term “seller” may relate to any user of the system associated with the sale of a good, service, or engagement in a partnership. The seller may include a sales representative, account manager, sales development representative, executive, or other member of an organization which may be involved in the sales cycle.

As used herein, the term “buyer” may relate to any user of the system associated with the purchase of a good, service, or engagement in a partnership. The buyer may include any individual or organization in communication with the seller.

As used herein, the term “sales cycle” includes each step of the business development and sales process. For example, the sales cycle may begin at the first contact or communication between the seller and the buyer and may end at the close of a sale. The sales cycle may also include following up on the sale to ensure buyer satisfaction.

In general, the embodiments provided herein relate to a purchase process collaboration system and evaluation system used during the sales cycle for a product, service, or partnership between one or more individuals and/or businesses. The purchase process collaboration system allows the seller to create an interactive buyer map of a plurality of buyers within at least one organization. The evaluation system will allow the seller to transmit an interactive evaluation center to the buyer who can input desired business outcomes, evaluation considerations, evaluations plans, documents, and other information into the evaluation system to aid both the buyer and seller through the sales cycle. In such, the buyer will utilize the evaluation center to indicate desired outcomes and goals for purchasing the product as well as considerations that may or may not need to be met for different features of a product the buyer wishes to buy. The seller can then utilize the input from the seller to ensure their product meets each outcome, goal, and considerations indicated by the buyer. The buyer may then invite third parties to utilize the evaluation center who may be competitors with the seller.

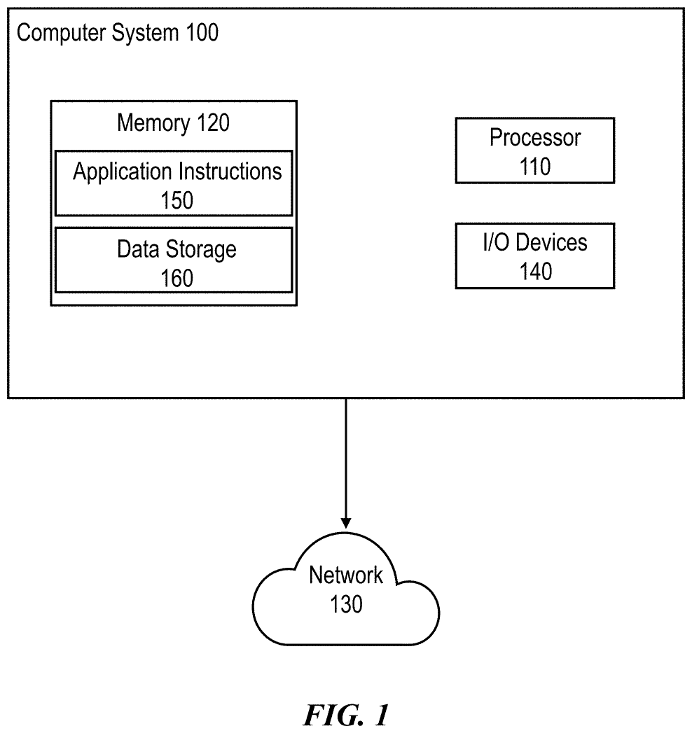

FIG. 1 illustrates a computer system 100, which may be utilized to execute the processes described herein. The computer system 100 is comprised of a standalone computer or mobile computing device, a mainframe computer system, a workstation, a network computer, a desktop computer, a laptop, or the like. The computer system 100 includes one or more processors 110 coupled to a memory 120 via an input/output (I/O) interface. Computer system 100 may further include a network interface to communicate with the network 130. One or more input/output (I/O) devices 140, such as video device(s) (e.g., a camera), audio device(s), and display(s) are in operable communication with the computer system 100. In some embodiments, similar I/O devices 140 may be separate from computer system 100 and may interact with one or more nodes of the computer system 100 through a wired or wireless connection, such as over a network interface.

Processors 110 suitable for the execution of a computer program include both general and special purpose microprocessors and any one or more processors of any digital computing device. The processor 110 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 100 and other devices attached to a network 130, such as other computer systems, or between nodes of the computer system 100. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol.

The memory 120 may include application instructions 150, configured to implement certain embodiments described herein, and a database 160, comprising various data accessible by the application instructions 150. In one embodiment, the application instructions 150 may include software elements corresponding to one or more of the various embodiments described herein. For example, application instructions 150 may be implemented in various embodiments using any desired programming language, scripting language, or combination of programming languages and/or scripting languages (e.g., C, C++, C#, JAVA®, JAVASCRIPT®, PERL®, etc.).

The steps and actions of the computer system 100 described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

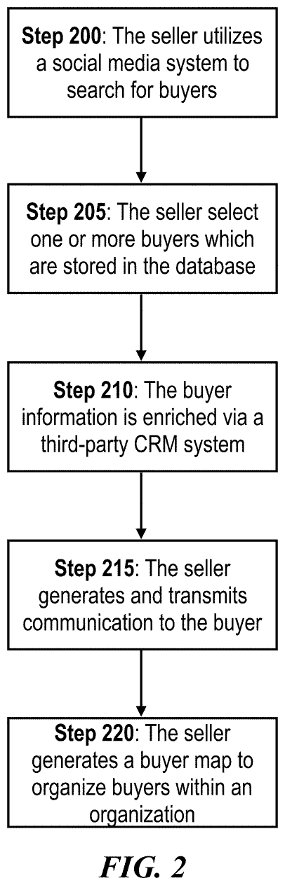

FIG. 2 illustrates a flowchart of a method wherein sellers and buyers are interacting with one another using the purchase process platform and evaluation system during a sales cycle. In step 200, the seller utilizes a social media system to search for organizations and members thereof (e.g., the buyer) which may be interested in the good or service they are selling. The purchase process platform and evaluation system (hereinafter referred to as “system” or “the system”) includes a plugin operating on the web browser of the sellers computing device. In step 205, the seller selects one or more buyers (i.e., stakeholders) and the buyer information is transmitted to the system via the plugin and stored in the system database. In step 210, the buyer information is enriched via a third-party to provide information such as the buyers email and phone number such that the seller can utilize the buyer information to contact the buyer and initiate the sales process. The sales process may include various strategies employed by the seller such as introducing the product and assessing interest, performing a demo of the product, scheduling a meeting with potential buyers, etc. In step 215, the seller generates and transmits outbound communication to the buyer via a communications system. In step 220, the seller generates a buyer map to organize buyers or other stakeholders within an organization or across various organizations which may aid the seller in executing a sale. The buyer map provides a strategic view of the potential buyers within the organization or who may be involved in the sale through partnerships with the potential buyers.

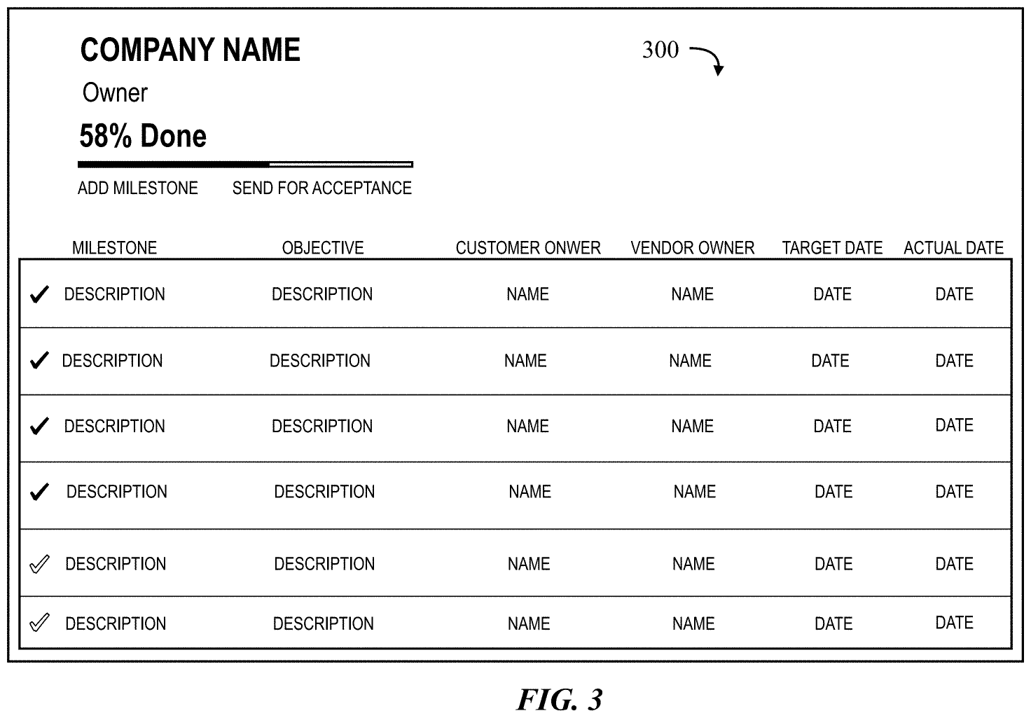

FIG. 3 illustrates a screenshot of the evaluation plan interface 300 which illustrates a plurality of milestones which may be reached throughout the sales cycle. The seller may input various information associated with each milestone such as an objective, owner (i.e., seller or associate thereof responsible for executing the milestone), vendor information, target date (i.e., the projected date the milestone will be completed), actual date (i.e., the date the milestone was completed), as well as the ability to edit or delete milestones. The evaluation plan interface 300 provides a templatized interface which is preloaded with milestones that the seller utilizes for the sales cycle of a product, service, or groups thereof. The seller is provided with a listing of predetermined milestone lists which they may select from based on the product or service they are selling. Once selected, the seller can edit the milestones, add new milestones, or delete milestones.

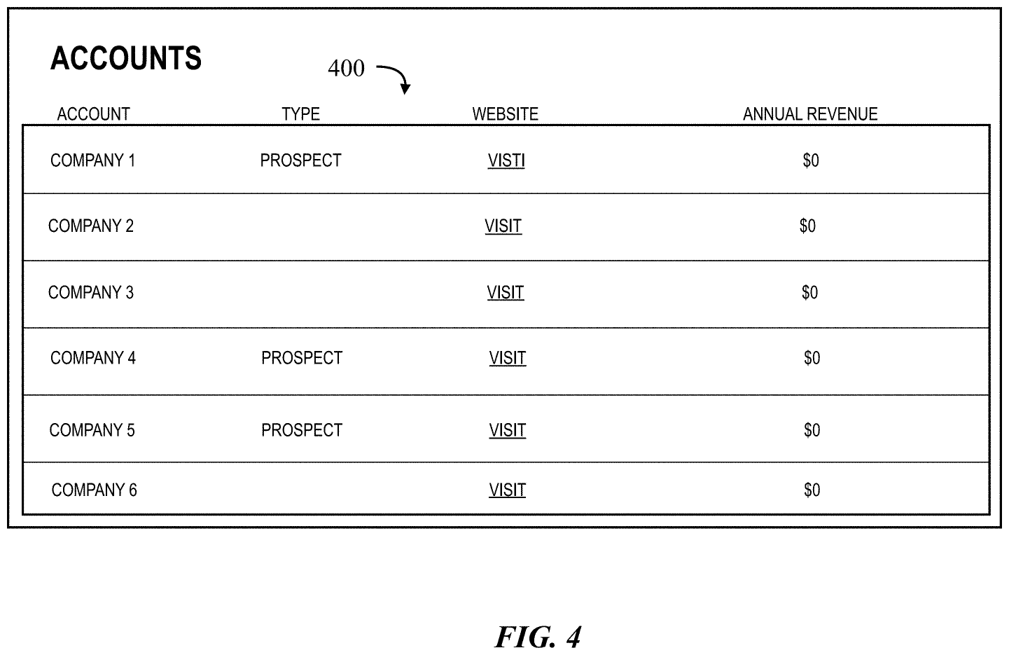

FIG. 4 illustrates a screenshot of the accounts interface 400 which includes a plurality of accounts each corresponding to a buyer with which the seller is engaged with. The seller may search for an account by searching the accounts database for the organization name, individual associated with the account, or other search criteria. Selecting an account will provide the user with contacts (i.e., the potential buyers and stakeholders) associated with the account and provide the seller with the opportunity to interact with the buyer information. The account information may be populated from a third-party CRM system or may be manually input by the seller.

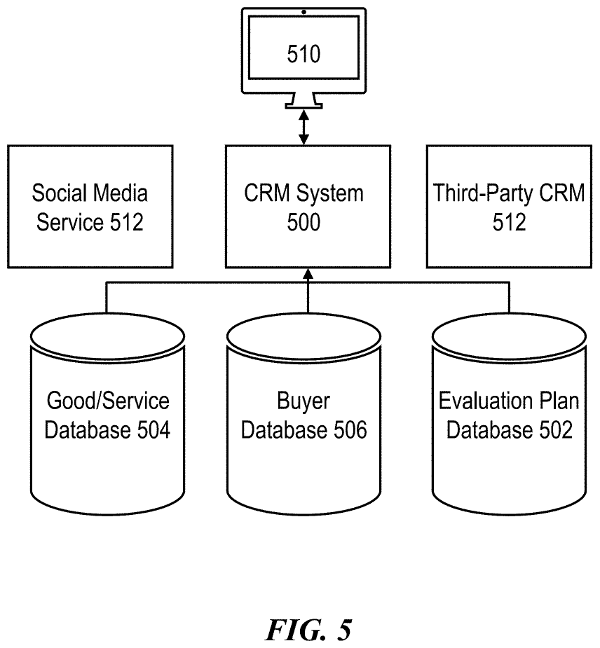

FIG. 5 illustrates a block diagram of the CRM system 500 comprising an evaluation plan database 502 which includes at least one preloaded list of milestones associated with each good or service provided by the seller. Each good or service is stored in the good/service database 504 which may include various information associated with the good or service which may be utilized seller while engaging in the sale cycle. A buyer database 506 stores buyer information including buyer contact information provided by a third-party CRM system 508 or input via the seller using the seller computing device 510. The buyer database 506 may also receive buyer information from third party data providers 512.

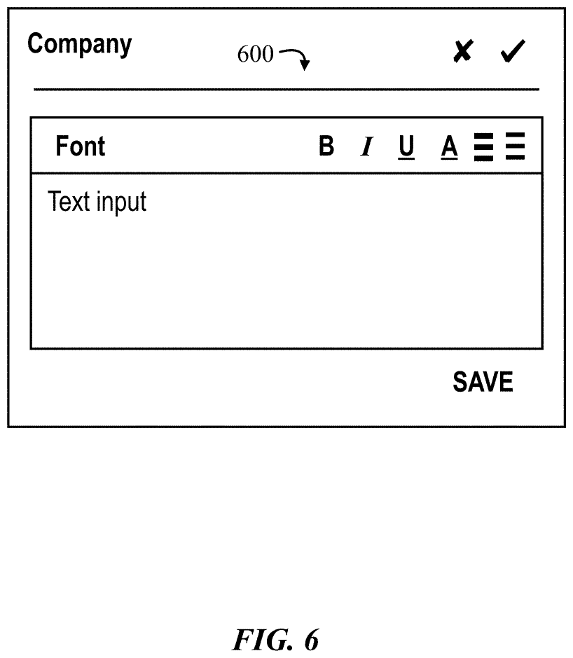

FIG. 6 illustrates a screenshot of the plugin interface 600 which provides the seller with a means for selecting buyers and inputting buyer information using a social media service. The buyers are selected by browsing a social media service using the web browser on the seller's computing device. The seller may then input notes related to the selected buyer which is transmitted to the buyer database wherein it is associated with the selected buyer. For example, the seller may select members of an organization who are account managers, product managers, technical experts, or executives who may be interested in the good or service the seller is selling. For instance, the seller may select a product manager as well as the executive supervising the product manager while making a note of their relationship, previous communications with either buyer, etc.

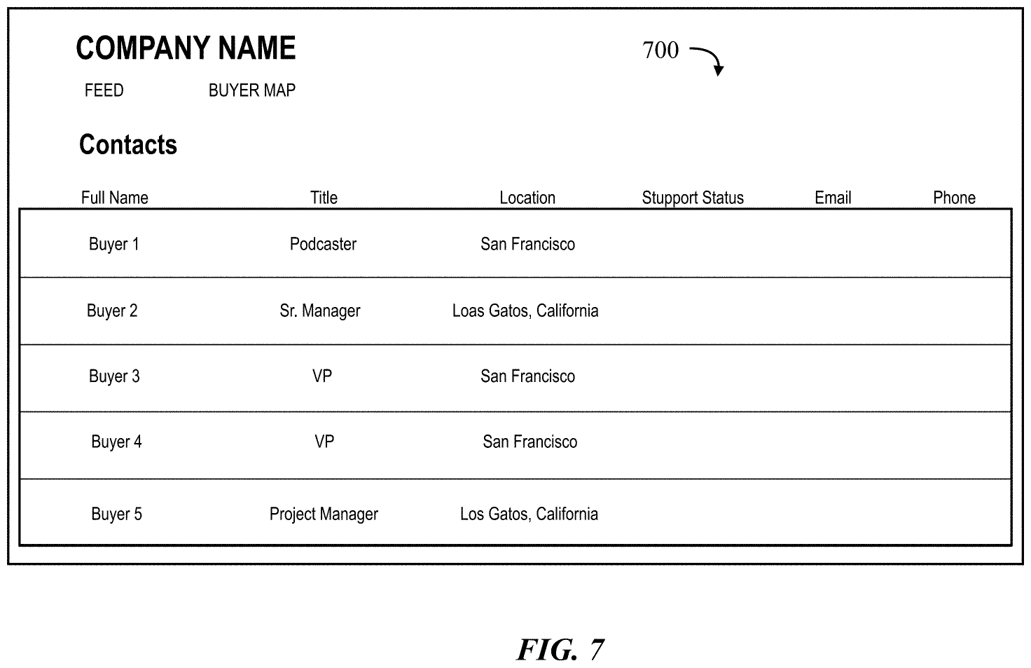

FIG. 7 illustrates a screenshot of the buyer enrichment interface 700 which includes a listing of a plurality of buyers associated with an organization. The buyer enrichment interface 700 allows the user to input a plurality of buyer information such as the buyer name, title, functional role, location, support status (i.e., whether or not the buyer supports the good or service provided by the seller, or whether or not the buyer likes the seller), and contact information.

In some embodiments, the support status may be determined by the seller based on communications between the buyer and seller, expressed interest in the product, previous sales or partnerships between the buyer and seller, etc. The seller may indicate each buyer or stakeholder as a supporter or non-supporter to allow the seller and users associated therewith to easily identify buyers who support the sellers good or service and may help complete the sales cycle with a successful sale.

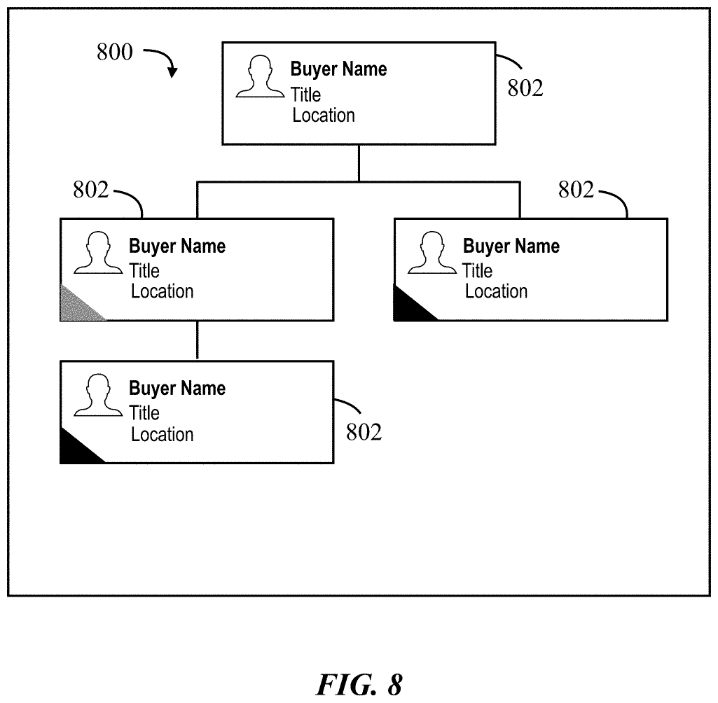

FIG. 8 illustrates a screenshot of the buyer map interface 800 which provides an interactive display of members of an organization or associated therewith (i.e., the buyers). Once the buyers are stored from the social media service, the seller may manually drag and drop the buyers which may be populated with information to create a buyer map. Each buyer 802 is illustrated within a buyer cell interface which provides a summary of the buyer's information such as their name, position, functional role, location, support status, and notes previously input by the seller. Alternatively, the seller may input notes on the buyer map interface 800. Notes may be input at any time throughout the sales cycle.

In some embodiments, the notes input by the seller may include one or more tags indicate other sellers who are involved with the sales cycle for a particular account. In such, the system can be used by groups of sellers to collaborate with one another throughout the sales cycle.

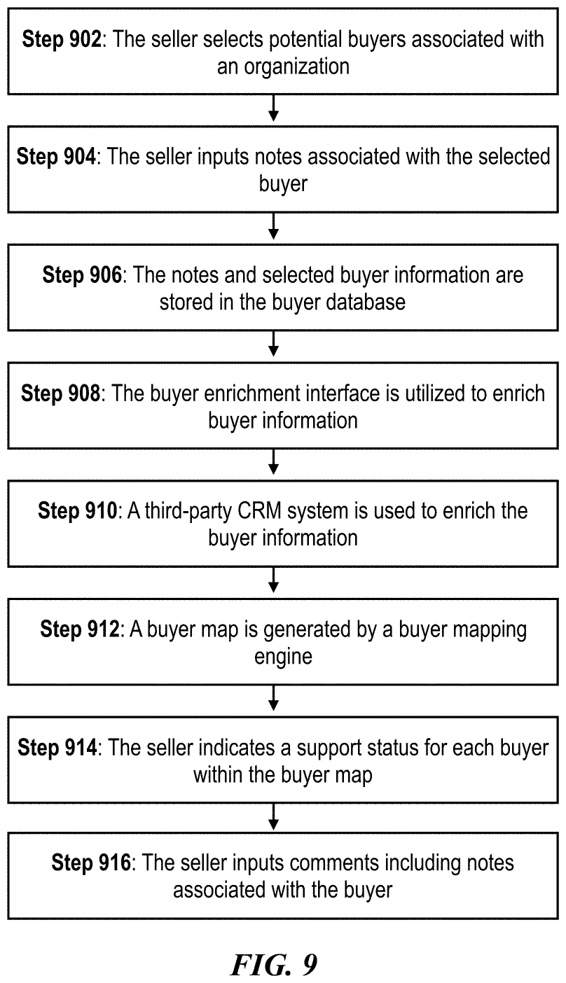

FIG. 9 illustrates a method for generating a buyer map utilizing the system described herein. In step 902, the seller selects one or more potential buyers associated with an organization. In step 904, the user input notes associated with the selected client via a browser plugin and the notes are associated with the buyer. The selected buyer and notes are stored in the buyer database in step 906. In step 908, the user may utilize the buyer enrichment interface to enrich the buyer information, and in step 910, a third-party system may be used to enrich the buyer information. In step 912, a buyer map is generated manually or automatically by a buyer mapping engine to provide a graphical representation of the buyer landscape within an organization and aid the seller in completing the sales cycle. In step 914, the seller may indicate the support status of each buyer. In such, the user selects whether the buyer is a supporter or non-supporter of the good or service, as well as their decision-status (e.g., their authorization to make decisions) within the organization. In step 916, the seller inputs a plurality of comments which may include notes associated with the buyer or account, as well as tags to communicate with other sellers associated with the buyer or seller. In one example, the tags may be used by the seller to communicate with an associate who has previous experience communicating with a buyer.

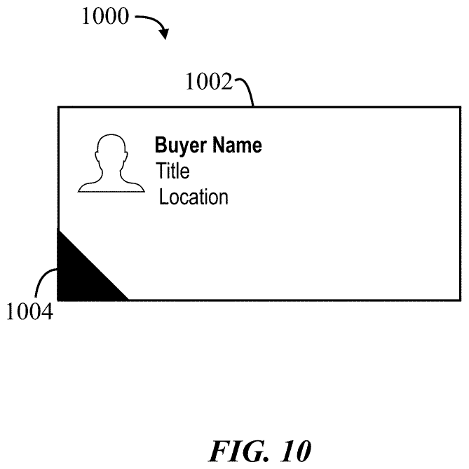

FIG. 10 illustrates screenshot of the buyer cell interface 1000 which is a subset of the buyer map interface. Each buyer cell 1002 corresponds to a buyer or other member of an organization associated with an account. The buyer cell includes buyer information such as the buyer name, position, functional role, location, and a status indicator 1004. The status indicator 1004 provides an simple and efficient means for determining whether or not a particular buyer supports or opposes the good or service being sold by the seller and where on the hierarchy the supporter or opposition exists. The status indicator 1004 may be color-coded (e.g., green indicating a support and red indicating a non-supporter), or otherwise coded as an indicator.

In some embodiments, the buyer cell interface 1000 may include an executive alignment indicator which indicates whether or not the buyer and an executive have been aligned to aid in the successful completion of the sales cycle. In one example, executive alignment indicator may be activated or deactivated by selecting the appropriate status via dropdown menu with prepopulated values.

In some embodiments, the buyer cell interface 1000 may include a decision status indicator which indicates the purchasing or decision authority each stakeholder has within their organization. Typical designations include, “Influencer, Evaluator, Economic Buyer, Decision Maker, Coach, Champion, etc.” The decision status indicator may operate via a dropdown menu with prepopulated values.

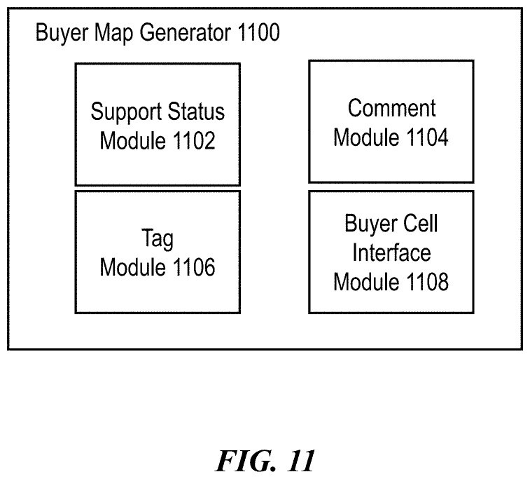

FIG. 11 illustrates a block diagram of the buyer map generator 1100 comprising a support status module 1102, a comment module 1104, a tag module 1106, and a buyer cell interface module 1108. The support status module 1102 receives an indication from the seller indicating whether or not the buyer is a support or non-supporter of the good or service sold by the seller and displays a corresponding color-coded indication on the buyer cell. The comment module 1104 receives input from the seller and associates the comment with the buyer or group of buyers. The tag module 1106 receives a tag from the seller (e.g., “@seller1) and associates the tag with the indicated seller which corresponds to the tag. The buyer cell interface module 1108 displays the buyer cell on the buyer map in the position indicated by the seller. The buyer cell may be moved to various locations along the buyer map with connections indicated by connecting lines between the plurality of buyer cells provided on the buyer map.

In some embodiments, the notification is transmitted to various third-party communications services to distribute the notification across multiple channels. The notifications may be distributed to users who have been tagged.

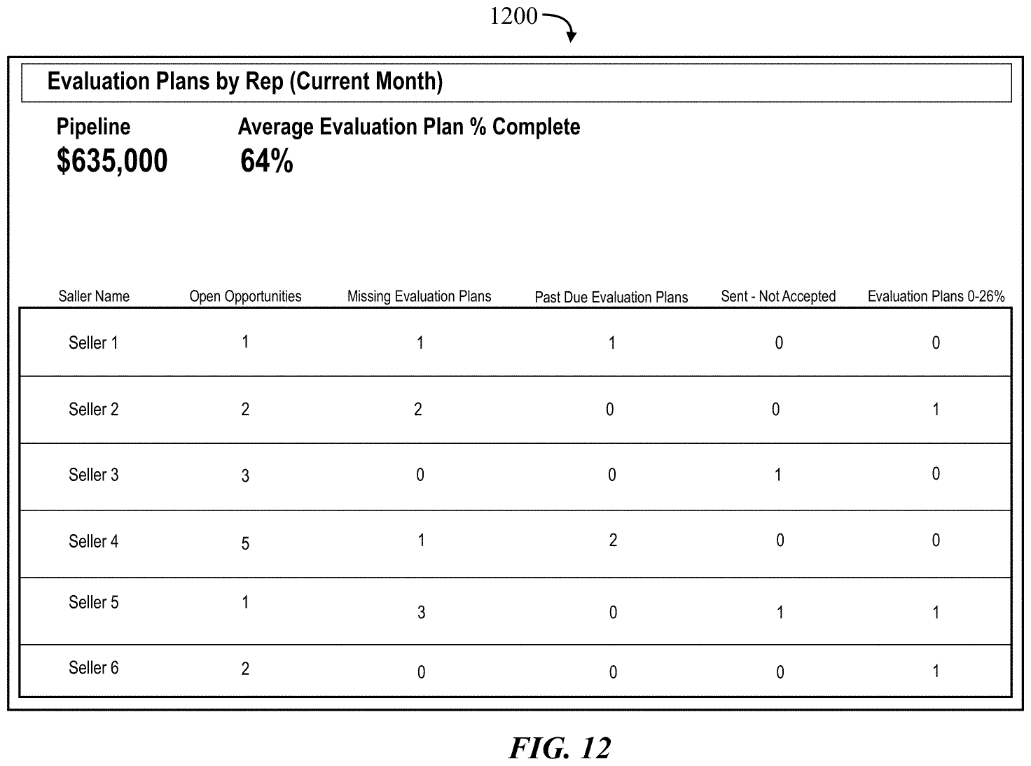

FIG. 12 illustrates a screenshot of the seller management interface 1200. In some instances, the seller management interface 1200 may be utilized by the manager of a sales team to view a representation of the sales pipeline, evaluation plan progress across an account or buyer, and other metrics useful for the management of a sales team. For example, the user may view a report for each seller which may include opportunities, evaluation plan statuses, missed deadlines, and other status indicators associated with milestones and evaluation plans for a buyer or account. The seller management interface 1200 receives information from the evaluation plan database to determine the status of each milestone or evaluation plan which is in progress.

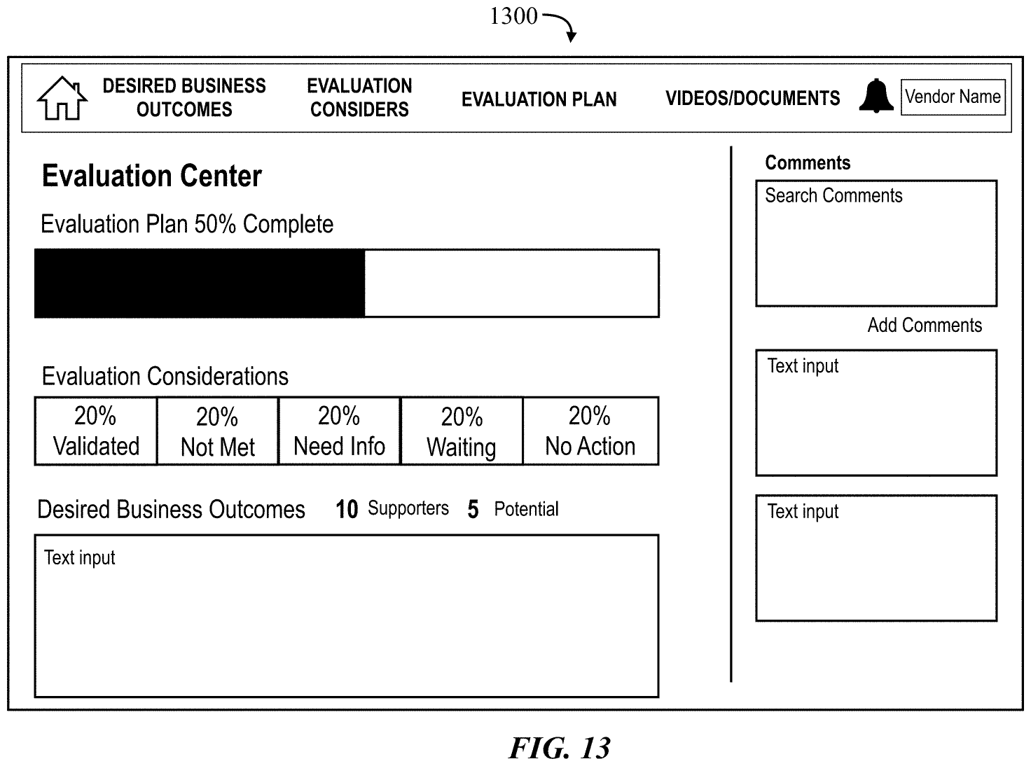

FIG. 13 illustrates a screenshot of the evaluation center interface 1300. The evaluation center is provided by the seller to the buyer to allow the buyer to evaluate the good or service provided by the seller. The evaluation center may also function to allow the buyer to invite third-party vendors and competitors of the seller to evaluate multiple competing goods or services in a single platform. The evaluation center interface 1300 includes a plurality of selectable tabs which when selected transmit the user to the interfaces described herein. The tabs include features for desired business outcomes, evaluation considerations, evaluation plans, and videos and documents. A completion status shows the status of the evaluation plan. The completion status is determined by the ratio of milestones completed to the total number of milestones input in the evaluation plan interface. The evaluation considerations status chart shows a visual representation of the status of whether or not the evaluation considerations provided in the evaluation consideration interface have been met, not met, needs more information, waiting for a reply, or whether or not an action has been taken.

In some embodiments, notifications may be automatically generated when the status of various objectives within the evaluation consideration. In one example, if a evaluation consideration is changed to “needs clarification”, a notification may be generated stating “needs clarification” for the specific evaluation status.

In some embodiments, when the buyer is engaging with the evaluation center, the seller is notified of the buyer's behavioral activities through an automated notification.

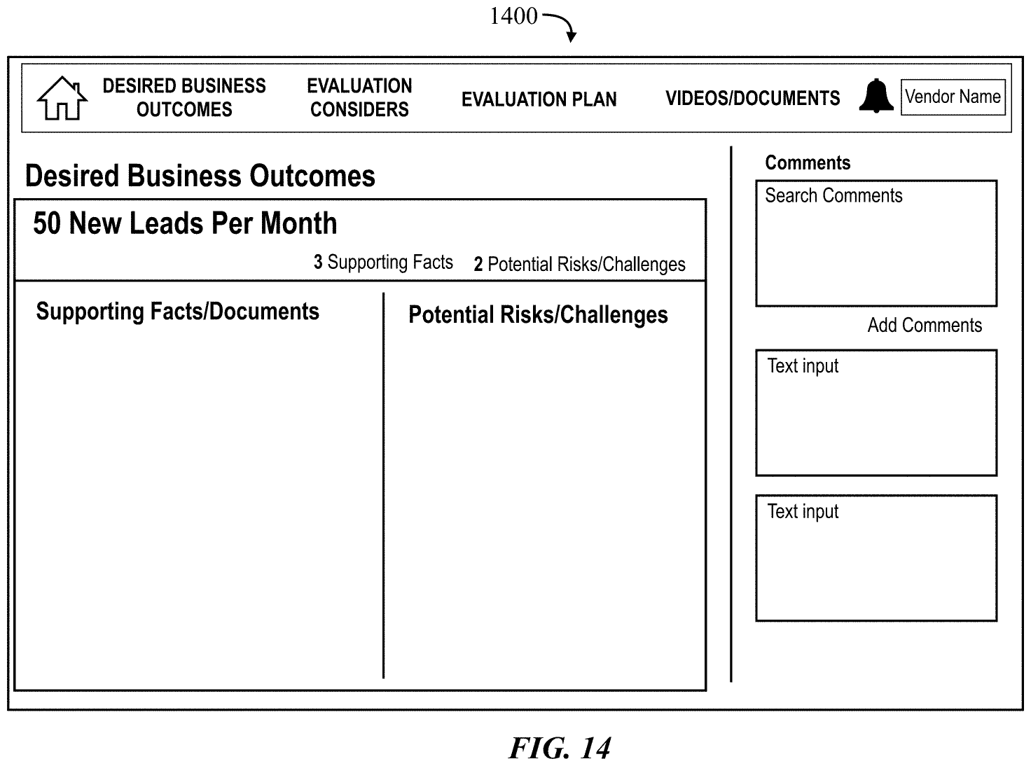

FIG. 14 illustrates a screenshot of the desired business outcomes interface 1400 wherein the buyer may input desired outcomes they want when purchasing the particular good or service provided by the seller. For example, the buyer may indicate that when purchasing a particular software product, they desire the product to aid in them achieving 50 new leads per month, deliver insights to their sales, and be able to quantify marketing impact on total revenue. The desired business outcomes interface 1400 allows the seller to monitor the desires and goals of the buyer and gives the seller the ability to address concerns by providing information related to their concerns.

In some embodiments, the desired business outcomes can include goals or objectives indicated by the buyer (e.g., increase sales by 10%, allow for integration with an email service, gain 50 new sales leads, etc.)

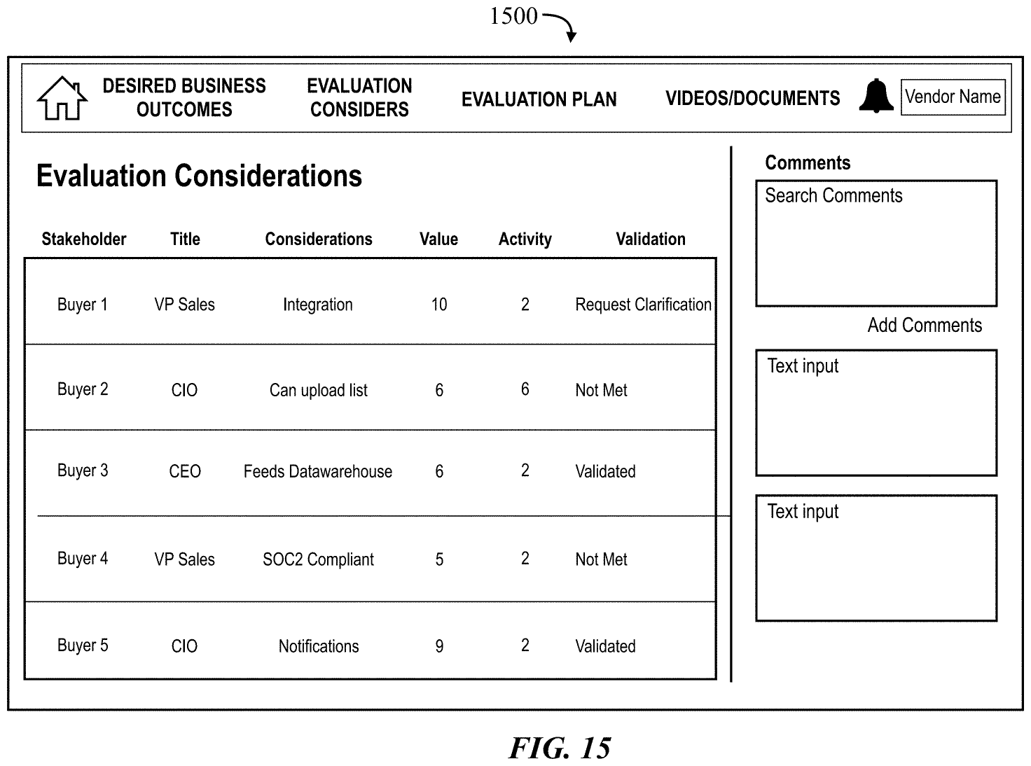

FIG. 15 illustrates a screenshot of the evaluation considerations interface 1500 which allows each buyer associated with an account to input a consideration to be made when purchasing the good or service. For example, a particular buyer may indicate that the ability to upload a list is of high value (e.g., a value of 8 out of 10) as indicated by the buyer. The seller or buyer may then validate that the product does allow for lists to be uploaded. A validation indicator displays whether or not each consideration has been validated. Comments may be input by the seller and/or buyers into the evaluation considerations interface 1500 to address considerations by permitting the communication between the buyer(s) and the seller. In some embodiments, a tagging function is available such that the user may tag another user which transmits a notification to the tagged user.

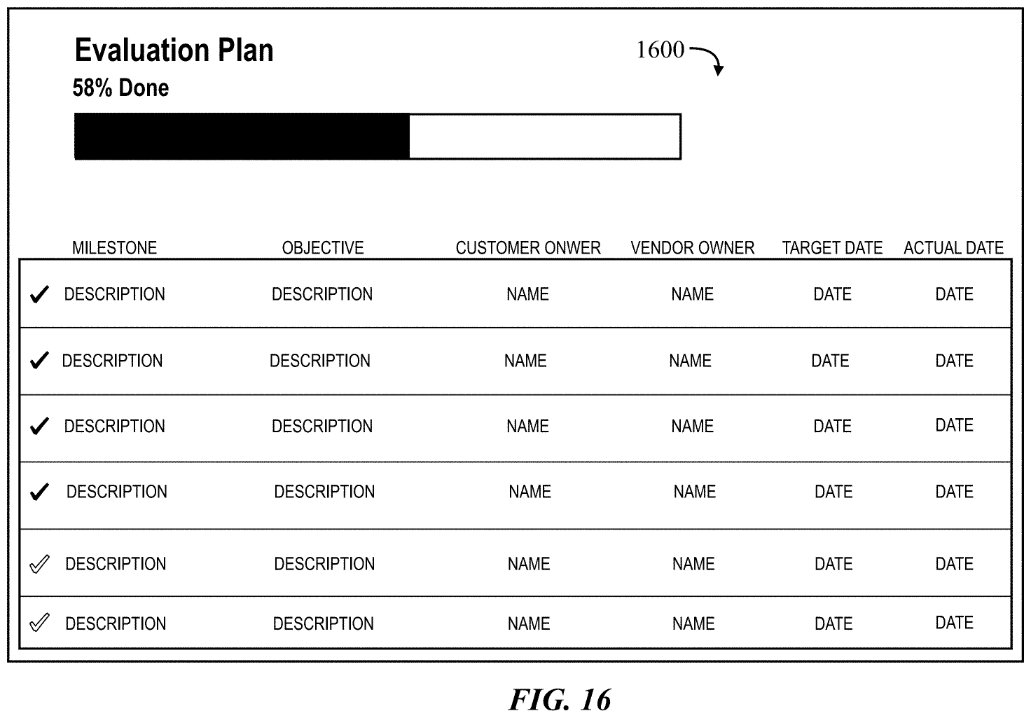

FIG. 16 illustrates a screenshot of the evaluation plan timeline interface 1600 is provided to the buyer having a status indicator to provide an indication of the completeness of each milestone within the evaluation plan. Similar to the evaluation plan interface shown in FIG. 3, the seller and/or buyer may input, via the evaluation plan timeline interface 1600 provided with the evaluation system, various information associated with each milestone such as an objective, owner (i.e., seller or associate thereof responsible for executing the milestone), vendor information, target date (i.e., the projected date the milestone will be completed), actual date (i.e., the date the milestone was completed), as well as the ability to edit or delete milestones.

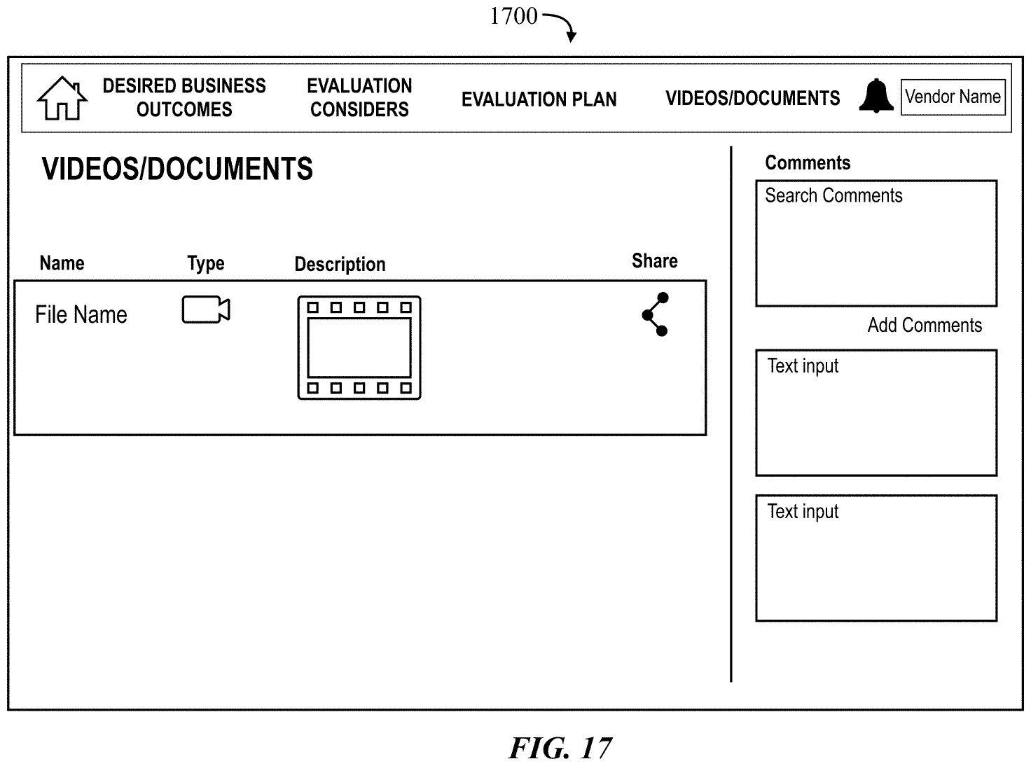

FIG. 17 illustrates a screenshot of the videos and documents interface 1700 wherein the seller and/or buyer may upload videos, presentations, and/or documents associated with the good or service provided by the seller. For example, the seller may upload a video of a product demonstration which the buyer can view during the evaluation process.

In some embodiment, the evaluation center and interfaces illustrated in FIGS. 13-17 each include a comment generator to allow for comments to be transmitted from the buyer(s) and/or seller to one another via a communication engine.

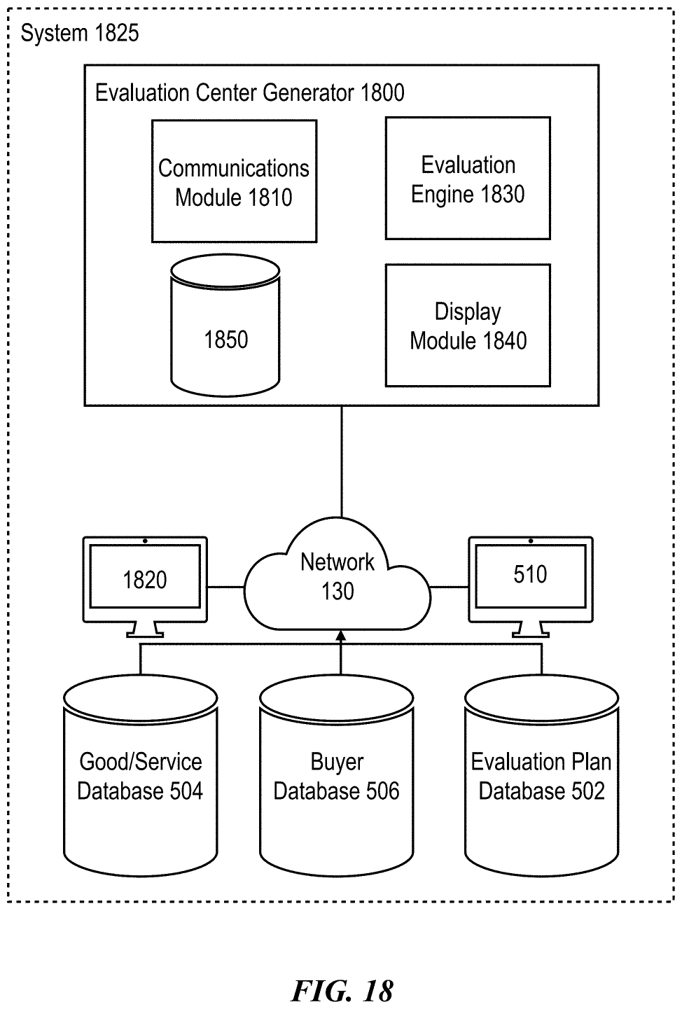

FIG. 18 illustrates a block diagram of the evaluation center generator 1800 which may be used by the seller to initiate the process of permitting a buyer or group of buyers to evaluate one or more good or services provided by the seller. The evaluation center generator 1800 receives information from the evaluation plan database 502, the good/service database 504, and the buyer database 506 to populate information provided to the buyer within the evaluation center. A communications module 1810 provides a comment interface to be provided on the evaluation center interfaces to allow the buyer and/or the seller to input communication via text which are transmitted and interacted with via the buyer computing device 1820 and seller computing device 510 in communication via the network 130 to transmit information to the system 1825. An evaluation engine 1830 receives evaluation input from the buyer and/or the seller and transmits the input to the interface via a display module 1840. An evaluation center database 1850 stores evaluation information input via the buyer and or seller.

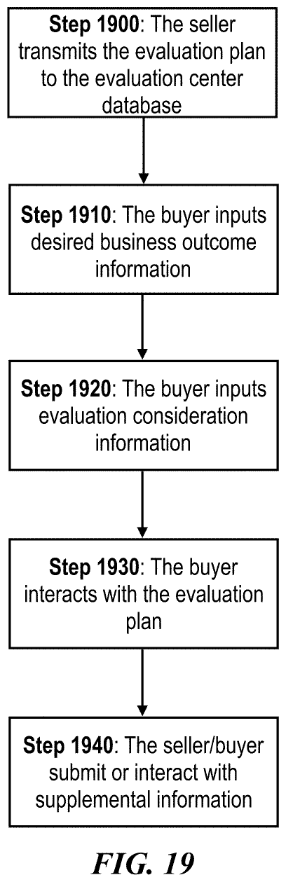

FIG. 19 illustrates a flowchart of the evaluation process facilitated by the system. In step 1900, the seller transmits the evaluation plan stored in the evaluation plan database to the evaluation center database. In step 1910, the buyer inputs desired business outcome information which is stored in the evaluation center database. In step 1920, the buyer inputs evaluation consideration information which is stored in the evaluation center database. In step 1930, the buyer interacts with evaluation plan information to indicate whether or not milestones have been met by either the seller or the buyer to complete the sales cycle. In step 1940, the seller and/or the buyer submit or interact with supplemental information such as videos, presentations, documents, and the like which relate to the good or service provided by the seller. Information input or milestones completed in steps 1900-1940 may be visually represented in status indicators provided on the evaluation center interfaces. For example, the percent of completion of milestones comprising the evaluation plan may be visualized in the evaluation center interface.

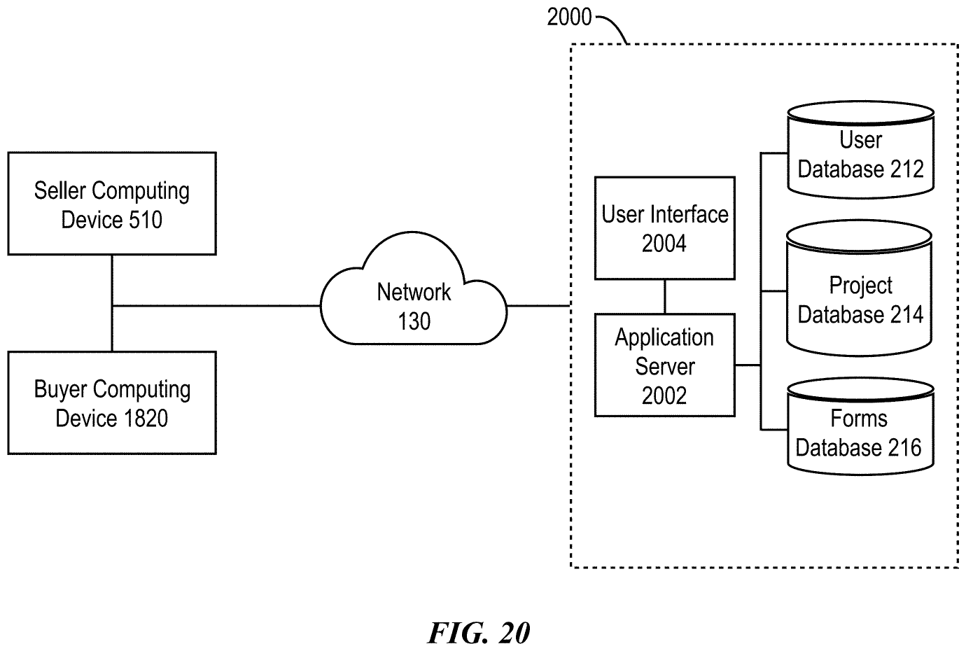

FIG. 20 illustrates a block diagram of the application system 2000 in operable communication with at least one seller computing device 510 and at least one buyer computing device 1820 in operable connection with the network 130. An application server 2002 is in operable communication with the network 130 to host the application system 2000 for generating the evaluation plan. The application system 2000 includes a user interface 2004 for providing a remote user (the buyer, the seller, or the third-party) with access to the application system 2000. The user interface is in operable communication with the buyer database 506, a good/service database 504, and the evaluation plan database 502. The application system 2000 provides the ability for buyers and sellers to interact with the various functionalities described by the embodiments hereinabove.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. An evaluation system for a good/service, the system comprising:
at least one seller computing device and at least one buyer computing device in operable connection with a network;
an application server in operable communication with the network, the application server configured to host an application system for generating an evaluation plan, the application system having a user interface for providing a remote user with access to the application system to the at least one seller computer and the at least one buyer computer, the user interface in operable communication with: a buyer database, a good/service database, and an evaluation plan database, the user interface comprising:
an evaluation center interface configured for displaying a status of the evaluation plan;
a desired business outcomes database configured for displaying one or more business outcomes;
an evaluation considerations interface configured for displaying one or more evaluation considerations;
an evaluation plan interface configured for displaying at least one evaluation plan; and
a video/document interface configured for displaying at least one video or document.

2. The system of claim 1, wherein the buyer database stores a plurality of buyer information comprising at least one of the following: a name, a position, a functional role, and a location.

3. The system of claim 1, wherein the evaluation center interface is accessible by the seller computing device, the buyer computing device, and a third party.

4. The system of claim 1, wherein the evaluation plan is comprised of one or more milestones representing a process in a sales cycle.

5. The system of claim 4, wherein each of the one or more milestones includes milestone information comprising: a name, a target date, and actual data, and an owner.

6. The system of claim 5, further comprising a seller management interface configured to display a representation of the milestones.

7. The system of claim 1, wherein the at least one video or document is a product demo provided by the seller computing device.

8. The system of claim 1, wherein each of the one or more evaluation considerations is validated by the seller or the buyer.

9. An evaluation system for a good/service, the system comprising:
at least one seller computing device and at least one buyer computing device in operable connection with a network;
an application server in operable communication with the network, the application server hosting an application system for generating an evaluation plan, the application system having a user interface for providing a remote user with access to the application system to the at least one seller computer and the at least one buyer computer, the user interface in operable communication with: a buyer database, a good/service database, and an evaluation plan database, the user interface comprising:
an evaluation center interface configured for displaying a status of the evaluation plan;
a desired business outcomes database configured for displaying one or more business outcomes;
an evaluation considerations interface configured for displaying one or more evaluation considerations;
an evaluation plan interface configured for displaying at least one evaluation plan;
a video/document interface configured for displaying at least one video or document;
a buyer map interface configured to receive a plurality of buyer information stored in the buyer database and generate, via a buyer map generator, the buyer map including one or more buyers from the plurality of buyer information; and
a comment interface configured to receive at least one communication and display the communication via the buyer map interface.

10. The system of claim 9, further comprising an accounts interface configured to display a plurality of accounts, wherein each of the plurality of accounts are associated with one or more buyers.

11. The system of claim 10, wherein the buyer map interface includes one or more buyer cell interfaces each displaying the plurality of buyer information.

12. The system of claim 11, wherein the one or more buyer cells include a support status indicator.

13. The system of claim 9, wherein the buyer database stores a plurality of buyer information comprising at least one of the following: a name, a position, a functional role, and a location.

14. The system of claim 9, wherein the evaluation center interface is accessible by the seller computing device, the buyer computing device, and a third-party.

15. The system of claim 9, wherein the evaluation plan is comprised of one or more milestones representing a process in a sales cycle.

16. The system of claim 15, wherein each of the one or more milestones includes milestone information comprising: a name, a target date, and actual data, and an owner.

17. The system of claim 16, further comprising a seller management interface configured to display a representation of the milestones.

18. The system of claim 17, wherein the at least one video or document is a product demo provided by the seller computing device.

19. The system of claim 18, wherein each of the one or more evaluation considerations is validated by the seller or the buyer.

20. An evaluation system for a good/service, the system comprising:
a seller computing device and a buyer computing device in operable connection with a network;
an application server in operable communication with the network, the application server hosting an application system for generating an evaluation plan including one or more milestones corresponding to a sales cycle,
wherein the application system includes a user interface for providing a remote user with access to the application system to the seller computer and the buyer computer,
wherein the user interface is in operable communication with: a buyer database, a good/service database, and an evaluation plan database, the user interface comprising:
an evaluation center interface for displaying a status of the evaluation plan and the one or more milestones associated thereto;
a desired business outcomes database for displaying a business outcomes generated on the buyer computing device;
an evaluation considerations interface for displaying an evaluation considerations input on the buyer computing device, wherein the evaluation considerations are validated by a buyer or a seller;
an evaluation plan interface for displaying the evaluation plan stored in the evaluation plan database; and
a video/document interface for displaying at least one video or document stored in the video/document database;
a buyer map interface configured to receive a plurality of buyer information stored in the buyer database and generate, via a buyer map generator, a buyer map including one or more buyers from the plurality of buyer information;
a comment interface configured to receive at least one communication and display the communication via the buyer map interface and the evaluation center interface; and
a tag generator to tag the remote user and transmit a notification to the remote user.
